(19) United States
(12) Patent Application Publication
(10) Pub. No.: US 2026/0089824 A1
(43) Pub. Date: Mar. 26, 2026

(54) INFORMATION TERMINAL, COMMUNICATION SYSTEM, SETTING METHOD, AND RECORDING MEDIUM

(71) Applicant: Panasonic Intellectual Property Management Co., Ltd., Osaka (JP)

(72) Inventors: Kazuma NISHIYASU, Nara (JP); Teruhito TAKEDA, Osaka (JP); Koji HOSHI, Osaka (JP); Naoaki YOSHIDA, Osaka (JP); Yuta TOMIO, Osaka (JP); Kosuke KAMEDA, Osaka (JP)

(21) Appl. No.: 19/319,874

(22) Filed: Sep. 5, 2025

(30) Foreign Application Priority Data
Sep. 20, 2024 (JP) 2024-164151

(51) Int. Cl. H05B 47/175; G06F 3/0482; G06F 3/04847; H05B 47/19

(52) U.S. Cl. CPC H05B 47/196; H05B 47/19; G06F 3/0482; G06F 3/04847

(57) ABSTRACT

An information terminal includes: a wireless communicator that receives a beacon signal emitted by a wireless communication device; a display; an information processor that displays, on the display, an operating mode selection screen displaying an option that varies depending on first information included in the beacon signal received; and an operation acceptor that accepts, from a user, a selection operation for selecting the operating mode. Using the wireless communicator, the information processor sends, to the wireless communication device, operating mode setting information for setting the operating mode selected by the selection operation in the wireless communication device.

### CROSS REFERENCE TO RELATED APPLICATION

This application claims the benefit of priority of Japanese Patent Application No. 2024-164151 filed on Sep. 20, 2024, the entire content of which is hereby incorporated by reference.

### TECHNICAL FIELD

The present disclosure relates to an information terminal used to make initial settings and the like in a communication system.

### BACKGROUND ART

Japanese Unexamined Patent Application Publication No. 2024-39914 discloses a lighting system including a lighting control device that transmits, to a lighting device, a dimming signal that controls dimming of the lighting device, and a mode signal pertaining to an operating mode.

### SUMMARY

The present disclosure provides an information terminal and the like capable of supporting the setting of an appropriate operating mode for a wireless communication device.

An information terminal according to one aspect of the present disclosure includes: a wireless communicator that receives a beacon signal emitted by a wireless communication device; a display; an information processor that displays, on the display, an operating mode selection screen displaying an option that varies depending on first information included in the beacon signal received; and an operation acceptor that accepts, from a user, a selection operation for selecting the operating mode. Using the wireless communicator, the information processor sends, to the wireless communication device, operating mode setting information for setting the operating mode selected by the selection operation in the wireless communication device.

A communication system according to one aspect of the present disclosure includes the information terminal and the wireless communication device.

A setting method according to one aspect of the present disclosure is a setting method executed by an information terminal including a display. The setting method includes: receiving a beacon signal emitted by a wireless communication device; displaying, on the display, an operating mode selection screen displaying an option that varies depending on first information included in the beacon signal received; accepting, from a user, a selection operation for selecting the operating mode; and sending, to the wireless communication device, operating mode setting information for setting the operating mode selected by the selection operation in the wireless communication device.

A recording medium according to one aspect of the present disclosure is a non-transitory computer-readable recording medium having recorded thereon a program for causing the information terminal to execute the setting method according to one aspect of the present disclosure.

The information terminal of the present disclosure is capable of supporting the setting of an appropriate operating mode for a wireless communication device.

### BRIEF DESCRIPTION OF THE DRAWINGS

The figures depict one or more implementations in accordance with the present teaching, by way of examples only, not by way of limitations. In the figures, like reference numerals refer to the same or similar elements.

FIG. 1 is a block diagram illustrating the configuration of a communication system according to an embodiment.

FIG. 2 is a diagram conceptually illustrating a mesh network.

FIG. 3 is a flowchart illustrating an overview of initial setting operations.

FIG. 4A is a first sequence chart illustrating initial setting operations.

FIG. 4B is a second sequence chart illustrating initial setting operations.

FIG. 5 is a diagram illustrating an example of an initial settings screen.

FIG. 6 is a sequence chart illustrating Example 1 of an operating mode setting phase.

FIG. 7A is a diagram illustrating Example 1 of an operating mode selection screen.

FIG. 7B is a diagram illustrating Example 2 of an operating mode selection screen.

FIG. 8 is a sequence chart illustrating Example 2 of an operating mode setting phase.

FIG. 9A is a diagram illustrating an example of a screen for setting control details of area control for a wireless communication device in which a lighting mode has been set.

FIG. 9B is a diagram illustrating an example of a screen for setting control details of area control for a wireless communication device in which a projector mode has been set.

FIG. 10 is a diagram illustrating an example of a method for assigning text indicating an operating mode.

FIG. 11 is a diagram illustrating an example of a relationship between details of control information and an operating mode.

FIG. 12 is a diagram illustrating an example of settings for a plurality of operating modes.

### DETAILED DESCRIPTION

An embodiment will be described in detail hereinafter with reference to the drawings. Note that the following embodiment describes comprehensive or specific examples of the disclosure. The numerical values, shapes, materials, constituent elements, arrangements and connection states of constituent elements, steps, orders of steps, and the like in the following embodiment are merely examples, and are not intended to limit the present disclosure. Additionally, of the constituent elements in the following embodiment, constituent elements not denoted in the independent claims will be described as optional constituent elements.

Note also that the drawings are schematic diagrams, and are not necessarily exact illustrations. Configurations that are substantially the same are given the same reference signs in the drawings, and redundant descriptions may be omitted or simplified.

### Embodiment

### Configuration

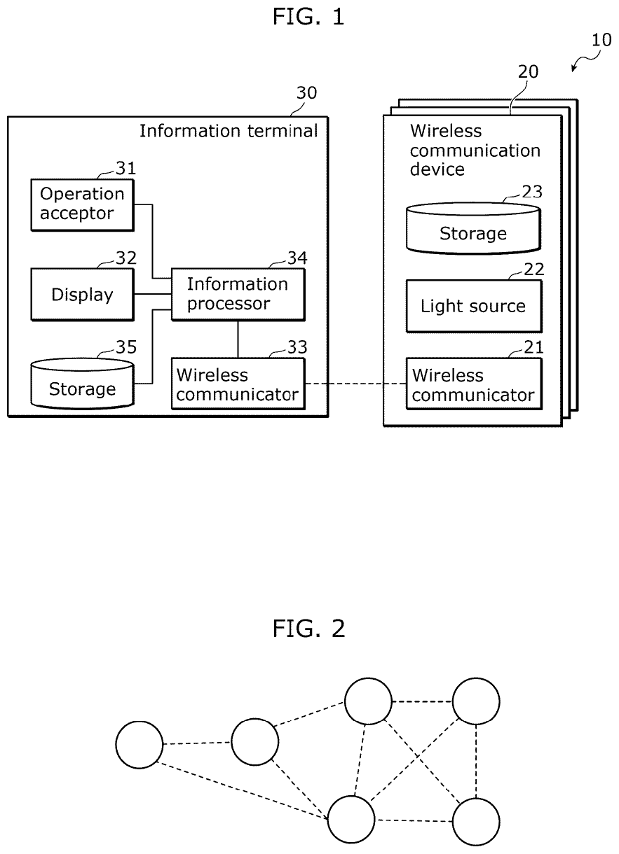

The configuration of a communication system according to an embodiment will be described first. FIG. 1 is a block diagram illustrating the configuration of the communication system according to the embodiment. As illustrated in FIG. 1, communication system 10 includes a plurality of wireless communication devices 20 and information terminal 30.

In communication system 10, each of the plurality of wireless communication devices 20 has wireless communication functionality, and the plurality of wireless communication devices 20 form a wireless mesh network (also called simply a “mesh network” hereinafter). The wireless mesh network is an example of a wireless communication network.

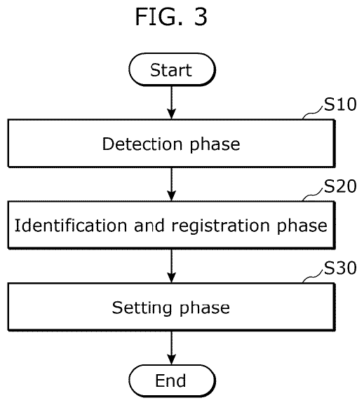

FIG. 2 is a diagram conceptually illustrating the mesh network. Each circle in FIG. 2 corresponds to one wireless communication device 20 (i.e., a communication node). In a mesh network, when information is transmitted from one communication node (also called a “first communication node”) to another communication node (also called a “second communication node”), the information is transmitted through routing, for example, but may be transmitted using other methods such as flooding.

Specifically, wireless communication device 20 is a lighting fixture, a lighting remote controller, a Pulse Width Modulation (PWM) dimmer, a scheduler, a projector, an alternating current (AC) relay, or the like. If wireless communication device 20 is a lighting fixture, the information transmitted over the mesh network is control information for controlling wireless communication device 20 to turn on, turn off, dim, or the like, for example. If an environment sensor is included in the mesh network (described later), a measured value from the environment sensor (sensing information) may be transmitted.

Wireless communication device 20 will be described first. As described above, wireless communication device 20 is a lighting fixture, a lighting remote controller, a PWM dimmer, a scheduler, a projector, an AC relay, a sensor, or the like.

The lighting fixture is, for example, a base light which is installed in a ceiling of an interior space and illuminates the interior space. Note that the form of wireless communication device 20 is not particularly limited, and may be a ceiling light, a downlight, a spotlight, or the like.

The PWM dimmer is a device capable of dimming a lighting fixture attached to the PWM dimmer. The scheduler is a device that turns on, turns off, or dims wireless communication device 20 according to a predetermined schedule. The projector is a device capable of projecting a moving image or a still image, and is used for effects, for example.

The AC relay includes two types, namely a first AC relay and a second AC relay. The first AC relay is a device that is attached to a wiring duct, and can turn on and off one device attached to the wiring duct by turning on and off AC power to that one device. The second AC relay is a device that is attached to the root of a wiring duct, and can turn on and off all devices attached to the wiring duct by turning on and off the supply of AC power to the wiring duct. The AC relay may also be a wireless control switch or the like that does not utilize a wiring duct.

The sensor is a human sensor, an environment sensor, or the like. Environment sensors include temperature sensors, humidity sensors, brightness sensors, carbon dioxide concentration sensors, Particle Matter (PM) sensors, and the like.

As described above, each of the plurality of wireless communication devices 20 has wireless communication functionality, and the plurality of wireless communication devices 20 form the mesh network. Wireless communication device 20 specifically includes wireless communicator 21, light source 22, and storage 23.

Wireless communicator 21 is wireless communication circuitry for wireless communication device 20 to communicate wirelessly (and more specifically, over radio waves) with other wireless communication devices 20 and information terminal 30. After wireless communication device 20 joins the mesh network, wireless communicator 21 communicates over the mesh network. Before wireless communication device 20 joins the mesh network, wireless communicator 21 periodically transmits a beacon signal (sometimes called an “advertising signal” or the like) and communicates wirelessly with information terminal 30 that receives the beacon signal. Specifically, wireless communicator 21 communicates wirelessly according to a communication standard such as Bluetooth (registered trademark) Low Energy (BLE) or Bluetooth (registered trademark) Mesh.

In an identification and registration phase (described later), light source 22 flashes to notify an installing party of a placement position of wireless communication device 20. Light source 22 is implemented as a Light Emitting Diode (LED) device, for example, but may be implemented as another light-emitting element such as a semiconductor laser, an organic electroluminescence (EL) device, an inorganic EL device, or the like. If wireless communication device 20 is a lighting fixture, light source 22 emits white light into an interior space in order to illuminate the interior space. If wireless communication device 20 is a device other than a lighting fixture, light source 22 is an LED indicator that emits red light.

Storage 23 is a storage device that stores various types of information necessary for wireless communication device 20 to operate, such as unique identification information, device type information, setting information (described later), operating mode setting information (described later), and option information (described later) for wireless communication device 20. Storage 23 is implemented as a semiconductor memory or the like, for example.

The configuration of information terminal 30 will be described next. Information terminal 30 is an information terminal used by a user to make settings (initial settings and setting changes) related to the mesh network and to control the plurality of wireless communication devices 20. Information terminal 30 is a mobile terminal such as a smartphone, a tablet terminal, or a Personal Digital Assistant (PDA), for example. Information terminal 30 may also be a dedicated remote controller used in communication system 10. Information terminal 30 specifically includes operation acceptor 31, display 32, wireless communicator 33, information processor 34, and storage 35.

Operation acceptor 31 accepts user operations. Specifically, operation acceptor 31 is implemented as a touch panel or the like.

Display 32 displays various images. Display 32 is implemented as a display panel such as a liquid crystal panel, an organic EL panel, or the like, for example.

Wireless communicator 33 is wireless communication circuitry for information terminal 30 to communicate wirelessly (and more specifically, over radio waves) with each of the plurality of wireless communication devices 20. Specifically, wireless communicator 33 communicates wirelessly according to a communication standard such as BLE.

Information processor 34 processes information in response to a user operation accepted by operation acceptor 31. Information processor 34 is implemented by a microcomputer, for example, but may be implemented by a processor or dedicated circuitry. The functions of information processor 34 are implemented by the hardware constituting information processor 34, such as a microcomputer or a processor, executing a computer program (software) stored in storage 35.

Storage 35 is a storage device that stores information necessary for information processing, such as a computer program executed by information processor 34. Storage 35 is implemented as semiconductor memory or the like, for example.

### Initial Setting Operations

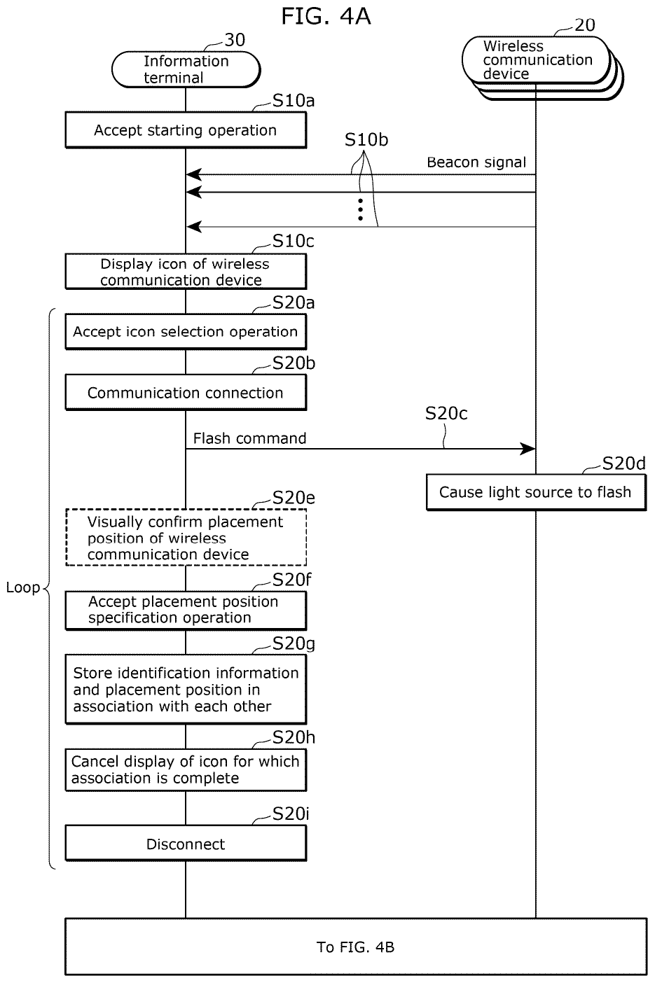

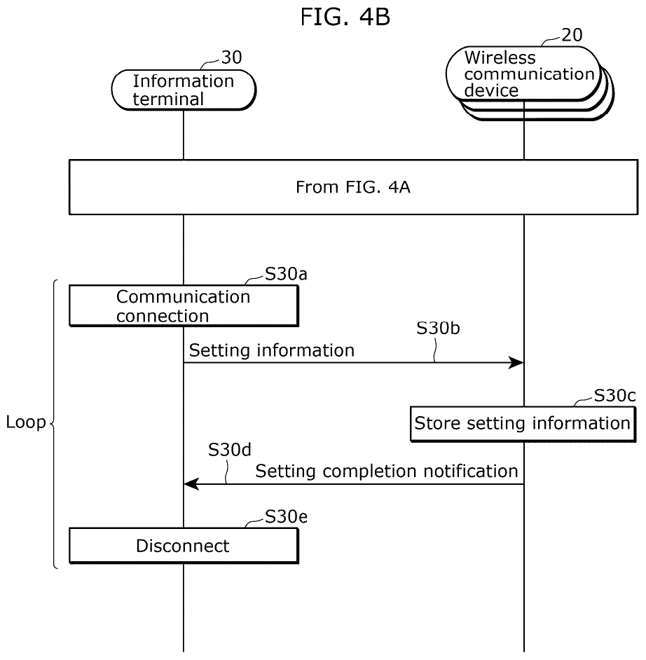

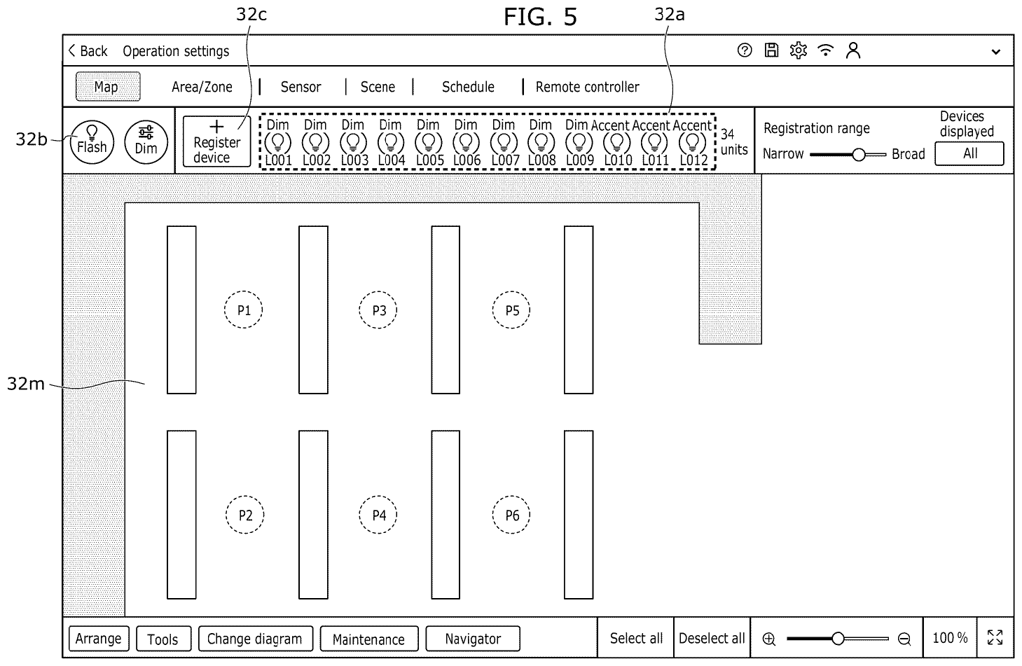

Information terminal 30 can construct a mesh network by performing initial setting operations. The initial setting operations will be described here. FIG. 3 is a flowchart illustrating an overview of the initial setting operations. As illustrated in FIG. 3, the initial setting operations include detection phase S10, identification and registration phase S20, and setting phase S30, in that order. Specific processing performed in each phase will be described hereinafter with reference to sequence charts. FIGS. 4A and 4B are sequence charts illustrating the initial setting operations. FIG. 5 is a diagram illustrating an example of an initial settings screen. The initial setting operations illustrated in FIGS. 4A and 4B are performed, for example, after the plurality of wireless communication devices 20 are installed in a ceiling by an installing party.

Processing performed in detection phase S10 will be described first. Operation acceptor 31 of information terminal 30 accepts, from the user, a starting operation for detecting wireless communication devices 20 (scanning) (S10a). The starting operation is an operation of tapping detection icon 32c in the initial settings screen illustrated in FIG. 5.

Here, before joining the mesh network, each of the plurality of wireless communication devices 20 periodically sends a beacon signal (sometimes called an “advertising signal” or the like) (S10b). In response to the starting operation of step S10a being accepted, wireless communicator 33 of information terminal 30 receives the beacon signal. The beacon signal emitted by each of the plurality of wireless communication devices 20 includes the unique identification information of the corresponding wireless communication device 20. The unique identification information may be a MAC (Media Access Control) address, for example, but is not limited to a MAC address as long as wireless communication device 20 can be uniquely identified.

Information processor 34 displays, on display 32, an icon of wireless communication device 20 that sent the received beacon signal (S10c). As illustrated in FIG. 5, in the initial settings screen, a plurality of icons 32a corresponding to the plurality of wireless communication devices 20 from which the beacon signals originated are displayed side by side in a row.

Map image 32m is also displayed in the initial settings screen illustrated in FIG. 5. Map image 32m is a view of the area where the plurality of wireless communication devices 20 are installed from above, and in the example in FIG. 5, placement positions P1 to P6 of wireless communication devices 20 are indicated by circles. In other words, map image 32m is an image indicating the placement positions of the plurality of wireless communication devices 20. Map image 32m is stored in storage 35 in advance.

At the time of step S10c, the manner in which the plurality of wireless communication devices 20 are arranged is known, but which wireless communication device 20 is located at which position is unknown. In other words, at the time of step S10c, the placement positions of wireless communication devices 20 are not yet associated with the unique identification information of wireless communication devices 20.

The processing of steps S10a to S10c described above is the processing performed in detection phase S10. Processing performed in identification and registration phase S20 will be described next.

Operation acceptor 31 accepts, from the installing party, a selection operation of the plurality of icons 32a (S20a). The selection operation is, for example, an operation of tapping one of the plurality of icons 32a. Based on the selection operation accepted by operation acceptor 31, information processor 34 establishes a communication connection between wireless communication device 20 corresponding to the selected icon 32a (also referred to as “target wireless communication device 20” hereinafter) and wireless communicator 33 (S20b), and starts individual communication (one-to-one communication) with target wireless communication device 20. Information processor 34 causes wireless communicator 33 to transmit a flash command (S20c). The flash command is transmitted in response to a tapping operation made on flash icon 32b made after the selection operation, for example.

The flash command is control information (a control command) for selectively causing target wireless communication device 20 to flash. Upon receiving the flash command, target wireless communication device 20 causes light source 22 to flash (S20d). This enables the user to identify target wireless communication device 20.

The user visually confirms the actual placement position of target wireless communication device 20 including light source 22 that is flashing (S20e), and specifies the placement position of target wireless communication device 20 including light source 22 that is flashing (e.g., one of placement positions P1 to P6) on map image 32m. Operation acceptor 31 accepts, from the user, an operation for specifying the placement position of wireless communication device 20 in map image 32m (S20f). Then, information processor 34 stores the unique identification information indicated by icon 32a selected in step S20a and the placement position (coordinates) specified in step S20f in association with each other in storage 35 (S20g). Information processor 34 also stops displaying icon 32a for which the association is complete (S20h). In other words, the number of the plurality of icons 32a displayed in step S10c is reduced by one. Information processor 34 then terminates the communication connection with target wireless communication device 20 (S20i).

The processing of steps S20a to S20i is repeated until all icons 32a (the unique identification information) displayed in step S10c are associated with placement positions. Correspondence information indicating the correspondence relationship between the unique identification information of the plurality of wireless communication devices 20 and the placement positions thereof is stored in storage 35 as a result. In other words, the plurality of wireless communication devices 20 are registered with information terminal 30.

The processing of steps S20a to S20i described above is the processing performed in identification and registration phase S20. Processing performed in setting phase S30 will be described next. The processing performed in setting phase S30 is processing which is also called “provisioning” or the like.

Based on an operation accepted by operation acceptor 31 for specifying one wireless communication device 20, information processor 34 establishes a communication connection between the specified wireless communication device 20 and wireless communicator 33 (S30a), and starts individual communication with wireless communication device 20. Information processor 34 then causes wireless communicator 33 to transmit setting information to wireless communication device 20 (S30b). Wireless communication device 20 receives the setting information and stores the setting information in storage 23 included in wireless communication device 20 (S30c).

The setting information is information for wireless communication device 20 to join the mesh network. The setting information includes a network ID of the mesh network to which wireless communication device 20 belongs, and address information (a unicast address) of wireless communication device 20 used for communication within the mesh network. If necessary, the setting information also includes a security passcode (authentication information) used for communication within the mesh network, channel information indicating a frequency channel used for wireless communication in the mesh network, and unique identification information of information terminal 30 that performed the initial setting operations. Wireless communication device 20 for which the setting information is stored in storage 23 can join the mesh network.

Once the setting information is stored, wireless communication device 20 transmits a setting completion notification to information terminal 30 (S30d). When the setting completion notification is received by wireless communicator 33, information processor 34 of information terminal 30 terminates the communication connection with wireless communication device 20 communicatively connected in step S30a (S30e).

The processing of steps S30a to S30e is repeated until all wireless communication devices 20 join the mesh network. If necessary, wireless communication device 20 which has joined the mesh network stops periodically transmitting the beacon signal sent before joining the mesh network.

The processing of steps S30a to S30e described above is processing performed in setting phase S30 (also called “setting processing”).

Note that the processing of step S20i and the processing of step S30a can be omitted. In other words, the processing of steps S30b to S30e may be performed without terminating the communication connection in step S20i.

Although the processing of steps S30b to 30d may be implemented by information terminal 30 communicating directly with the target wireless communication device, the same processing may also be implemented by information terminal 30 establishing a communication connection with another wireless communication device 20 and communicating with the target wireless communication device over the mesh network (via the other wireless communication device 20).

As described above, information terminal 30 can cause the plurality of wireless communication devices 20 to join the mesh network by performing the initial setting operations. In other words, information terminal 30 can construct a mesh network.

### Example 1 of Operating Mode Setting Phase

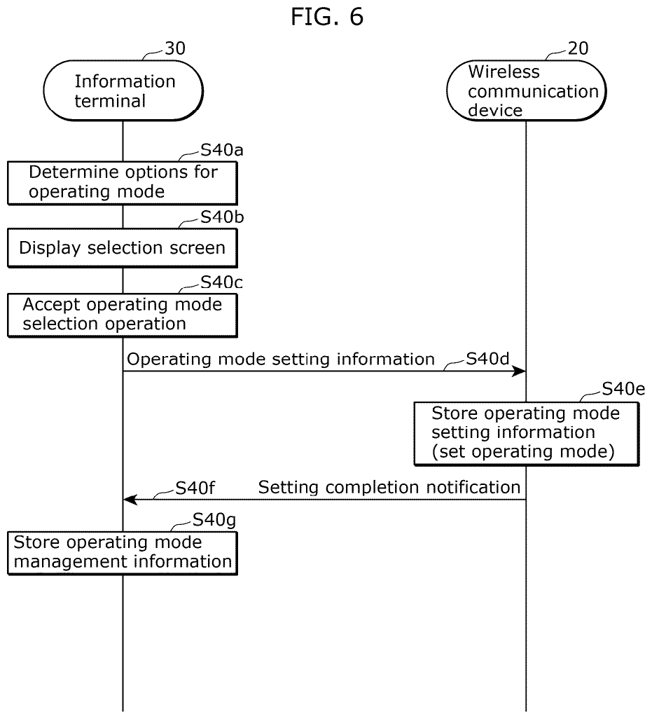

Incidentally, it is conceivable to implement a configuration in which wireless communication device 20 is caused to operate according to the device type of that wireless communication device 20, by making the software stored in storage 23 of wireless communication device 20 the same (common) regardless of the device type of wireless communication device 20 and then setting the operating mode of wireless communication device 20 (the software). In such a case, an operating mode setting phase is required. Processing performed in the operating mode setting phase will be described hereinafter. FIG. 6 is a sequence chart illustrating Example 1 of the operating mode setting phase.

The operating mode setting phase will be described hereinafter as a separate phase from both identification and registration phase S20 and setting phase S30. However, the operating mode setting phase may be part of identification and registration phase S20 or setting phase S30.

Additionally, the following will describe an example in which each process included in the operating mode setting phase is implemented by information terminal 30 establishing a direct communication connection with target wireless communication device 20. However, each process included in the operating mode setting phase can also be implemented by information terminal 30 establishing a communication connection with another wireless communication device 20 and communicating with target wireless communication device 20 over the mesh network (via the other wireless communication device 20).

Information processor 34 of information terminal 30 determines options for the operating mode in accordance with the device type information included in the beacon signal received in step S10b (S40a). In other words, information processor 34 determines options for the operating mode according to the device type of wireless communication device 20 that sent the beacon signal. The device type information indicates one of a plurality of types, such as “lighting fixture”, “sensor”, or the like, for example. Information processor 34 determines the options based on correspondence relationships between device types and appropriate options, determined in advance. For example, if the device type information indicates that the device is a lighting fixture, “lighting mode”, “repeater mode”, and “projector mode” are determined as options. If the device type information indicates that the device is a sensor, “sensor mode” and “repeater mode” are determined as options.

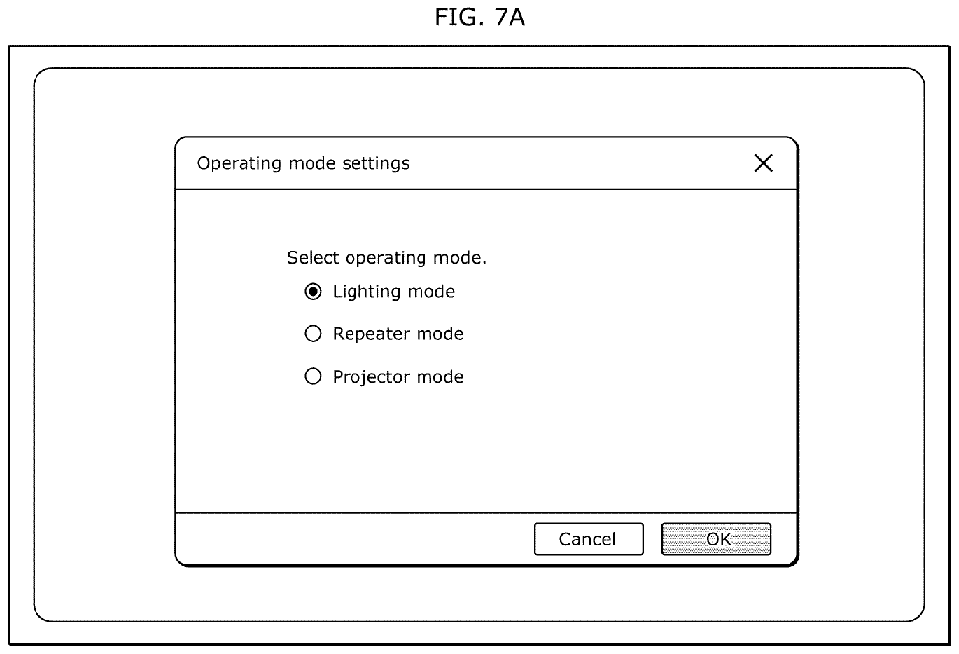

Information processor 34 displays a selection screen including the determined operating mode options on display 32 (S40b). FIGS. 7A and 7B are diagrams illustrating an example of the operating mode selection screen. FIG. 7A illustrates the selection screen when the device type information indicates that the device is a lighting fixture, and FIG. 7B illustrates a selection screen when the device type information indicates that the device is a sensor.

The operating modes will be described in further detail here. Lighting mode is an operating mode in which wireless communication device 20 operates as a communication node in the mesh network (i.e., communicates wirelessly) and as a lighting fixture. Projector mode is an operating mode in which wireless communication device 20 operates as a communication node in the mesh network and as a projector. Sensor mode is an operating mode in which wireless communication device 20 operates as a communication node in the mesh network and as a sensor. In other words, these operating modes correspond to an operating mode in which wireless communication and operations according to the device type of wireless communication device 20 (operations corresponding to a main function unique to wireless communication device 20) are performed (also called a “first operating mode”hereinafter).

On the other hand, the repeater mode is an operating mode in which, of operation as a communication node in the mesh network (wireless communication) and operations according to the device type of wireless communication device 20, only the operation as a communication node in the mesh network is performed (also called a “second operating mode” hereinafter).

In this manner, the options displayed in the operating mode selection screen include the first operating mode, for performing wireless communication and operations according to the device type of wireless communication device 20, and the second operating mode, for performing only wireless communication among the wireless communication and operations according to the device type of wireless communication device 20. The first operating mode also includes an operating mode for a lighting fixture and an operating mode for a device other than a lighting fixture (e.g., a projector, a sensor, or the like).

The installing party performs an operating mode selection operation, and operation acceptor 31 accepts the operating mode selection operation (S40c).

In addition, using wireless communicator 33, information processor 34 sends, to wireless communication device 20, operating mode setting information for setting the operating mode selected by the selection operation in wireless communication device 20 (S40d). Wireless communication device 20 receives the operating mode setting information and stores the operating mode setting information in storage 23 included in wireless communication device 20 (S40e). The operating mode is set for wireless communication device 20 for which the operating mode setting information is stored in storage 23.

Once the operating mode setting information is stored, wireless communication device 20 transmits a setting completion notification to information terminal 30 (S40f).

When the setting completion notification is received by wireless communicator 33, information processor 34 of information terminal 30 stores the unique identification information included in the beacon signal received in step S10b and the operating mode selected in step S40c in association with each other in storage 35 as operating mode management information (S40g).

The processing of steps S40a to S40g is performed for all wireless communication devices 20 for which it is necessary to set the operating mode.

In this manner, information terminal 30 can display, on display 32, an operating mode selection screen having different options depending on the device type information included in the beacon signal. As a result, only operating modes appropriate for setting in wireless communication device 20 are included as options in the selection screen. Accordingly, the user can select an operating mode appropriate for wireless communication device 20 according to the device type of wireless communication device 20.

In Example 1 of the operating mode setting phase, information processor 34 determines the options based on the device type information included in the beacon signal (i.e., information indicating the options indirectly) and the correspondence relationship between the device type stored in storage 35 in advance and the appropriate options. However, the beacon signal may include option information that directly indicates the operating mode options aside from the device type information, and information processor 34 may display a selection screen including the options indicated by the option information (omitting the processing for determining the options from the device type information).

Even in this case, the option information indicates an option suitable for wireless communication device 20 that holds that option information, and the user can therefore set an appropriate operating mode for wireless communication device 20.

### Example 2 of Operating Mode Setting Phase

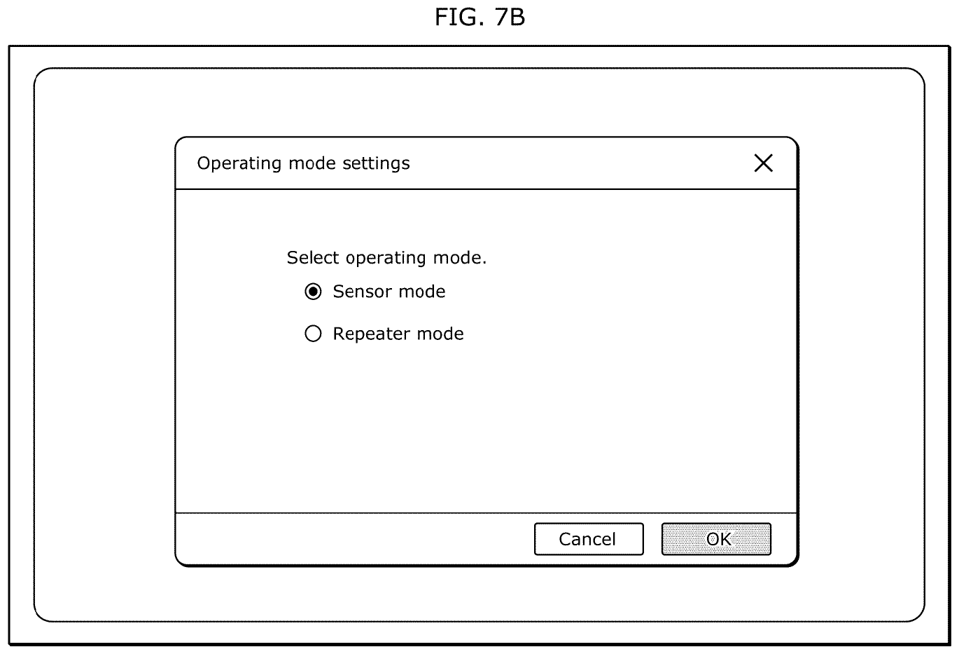

The option information may be provided to information terminal 30 from wireless communication device 20 in response to a request from information terminal 30. FIG. 8 is a sequence chart illustrating Example 2 of the operating mode setting phase.

The operating mode setting phase will be described hereinafter as a separate phase from both identification and registration phase S20 and setting phase S30. However, the operating mode setting phase may be part of identification and registration phase S20 or setting phase S30.

Additionally, the following will describe an example in which each process included in the operating mode setting phase is implemented by information terminal 30 establishing a direct communication connection with target wireless communication device 20. However, each process included in the operating mode setting phase can also be implemented by information terminal 30 establishing a communication connection with another wireless communication device 20 and communicating with target wireless communication device 20 over the mesh network (via the other wireless communication device 20).

Information processor 34 of information terminal 30 sends an information provision request for the option information to wireless communication device 20 using wireless communicator 33 (S40h). Wireless communication device 20 receives the information provision request and sends the option information to information terminal 30 in response to the received information provision request (S40i).

When the option information is received by wireless communicator 33, information processor 34 of information terminal 30 displays a selection screen including the operating mode options indicated by the option information on display 32 (S40b). The processing thereafter is the same as in Example 1 of the operating mode setting phase.

In this manner, information terminal 30 can query wireless communication device 20 for options suitable for wireless communication device 20, and display an operating mode selection screen including the appropriate options on display 32. The user can then set an appropriate operating mode for wireless communication device 20.

### Area Control

Information terminal 30 can group the plurality of wireless communication devices 20 and instruct control to be performed as a group. Information terminal 30 can reduce the number of instances of communication by sending control information in which identification information indicating the group is designated as a destination. Hereinafter, an “area” will be described as an example of a group of the plurality of wireless communication devices 20, the identification information indicating the group will be referred to as “area identification information”, and control of wireless communication devices 20 using the area identification information will be referred to as “area control”.

Here, when wireless communication devices 20 having different operating modes coexist in the same area (group), there will be some wireless communication devices 20 that cannot operate in accordance with the control instructed by the control information.

Accordingly, information processor 34 accepts an area setting for setting the area of the plurality of wireless communication devices 20 on the condition that the set operating modes are identical. For example, when an operation is performed to cause wireless communication devices 20 having different operating modes set by a setting party to belong to the same area, information processor 34 notifies the installing party that it is necessary to redo the area setting by displaying a message in display 32 or the like, and does not accept the area setting. In addition, information processor 34 may display, on display 32, a setting screen that prevents wireless communication devices 20 having different operating modes from belonging to the same area (a setting screen having a modified GUI). Note that which operating mode is set for which wireless communication device 20 can be identified by referring to the operating mode management information stored in storage 35.

In this manner, information terminal 30 can implement appropriate area control as long as only wireless communication devices 20 having the same operating mode set belong to the same area.

Note that wireless communication device 20 for which the sensor mode, the repeater mode, or the like is set are excluded from the control. Accordingly, information processor 34 excludes wireless communication devices 20 for which a specific operating mode, such as the sensor mode or the repeater mode, is set from the area setting (i.e., from the group setting or grouping).

For example, when an operation is performed to cause wireless communication device 20 having a specific different operating mode set by a setting party to belong to an area, information processor 34 notifies the installing party that it is necessary to redo the area setting by displaying a message in display 32 or the like, and does not accept the area setting. In addition, information processor 34 may exclude wireless communication device 20 for which a specific operating mode is set from the area setting by not displaying wireless communication device 20 for which the specific operating mode is set as a selection candidate in the area setting screen. Note that which wireless communication device 20 is set to the specific operating mode can be identified by referring to the operating mode management information stored in storage 35.

In this manner, information terminal 30 can implement appropriate area control as long as wireless communication device 20 for which the specific operating mode is set is excluded from the area control.

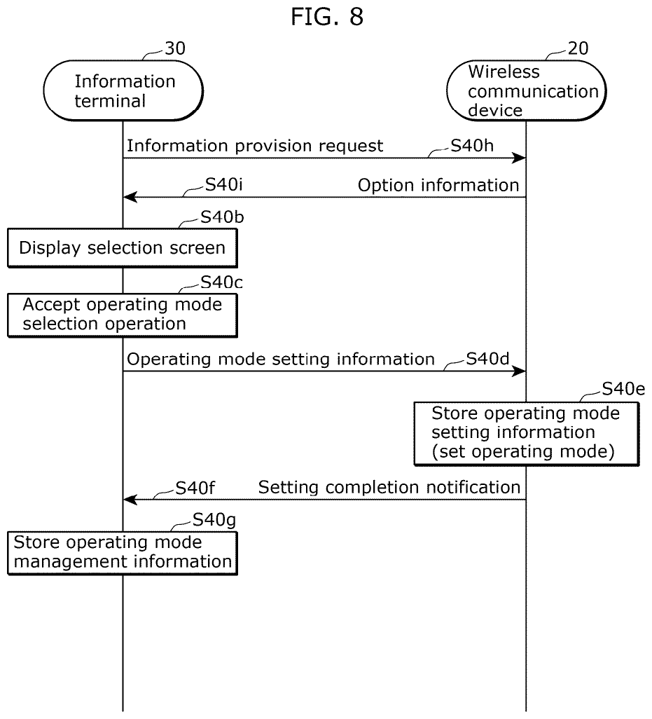

Note that the screen for setting control details of the area control differs depending on the operating mode of wireless communication devices 20 that belong to the area. FIG. 9A is a diagram illustrating an example of a screen for setting control details of area control for wireless communication device 20 in which lighting mode has been set. FIG. 9B is a diagram illustrating an example of a screen for setting control details of area control for wireless communication device 20 in which projector mode has been set.

In this manner, information terminal 30 (information processor 34) can implement an appropriate screen display by changing the display format of a screen pertaining to wireless communication device 20 displayed on display 32 in accordance with the operating mode set in wireless communication device 20.

### Icon Display Format

As described above, in S10 of the detection phase, the plurality of icons 32a are displayed on display 32. Here, the word “dim” at the top of icon 32a means the device type of wireless communication device 20, which is displayed based on the device type information included in the beacon signal. For example, “dim” means that wireless communication device 20 is a dimmable lighting fixture. Text such as “L001” below icon 32a is an identification number for distinguishing icon 32a.

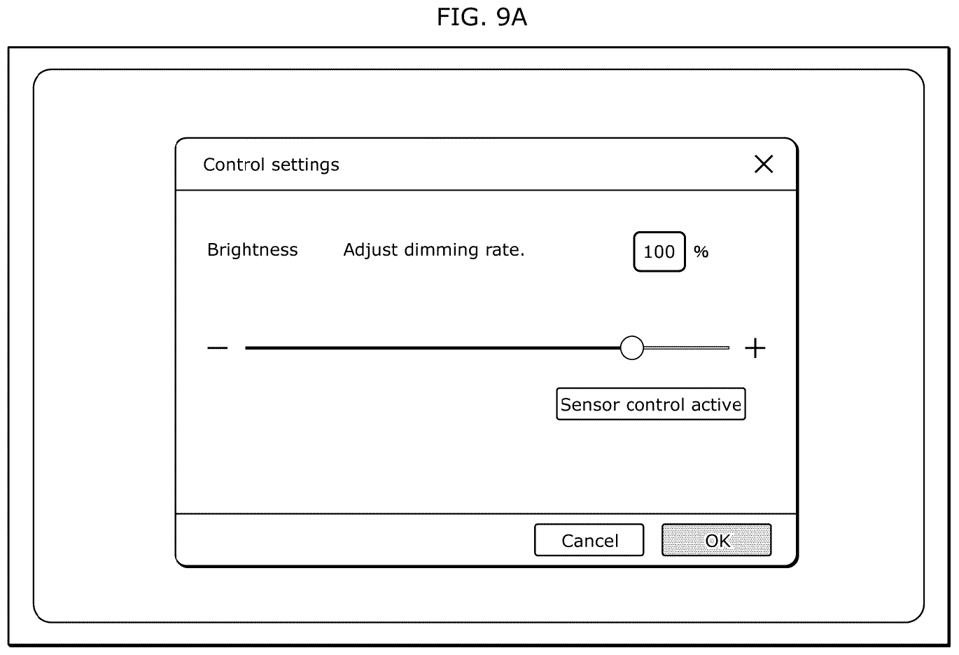

Here, after the operating mode is set for wireless communication device 20, text indicating the operating mode may be assigned to icon 32a. FIG. 10 is a diagram illustrating an example of a method for assigning text indicating the operating mode. As illustrated in FIG. 10, information processor 34 of information terminal 30 assigns text indicating the operating mode to icon 32a instead of text indicating the device type above icon 32a, for example.

In this manner, information terminal 30 (information processor 34) can implement an appropriate screen display by changing the display format of icon 32a pertaining to wireless communication device 20 displayed on display 32 in accordance with the operating mode set in wireless communication device 20.

Note that the display format illustrated in FIG. 10 is merely one example, and the change in the display format of icon 32a in accordance with the operating mode may be implemented by changing at least one of the color, pattern, size, shape, or the like of icon 32a.

### Differences in Behavior of Wireless Communication Device Upon Receiving Control Information

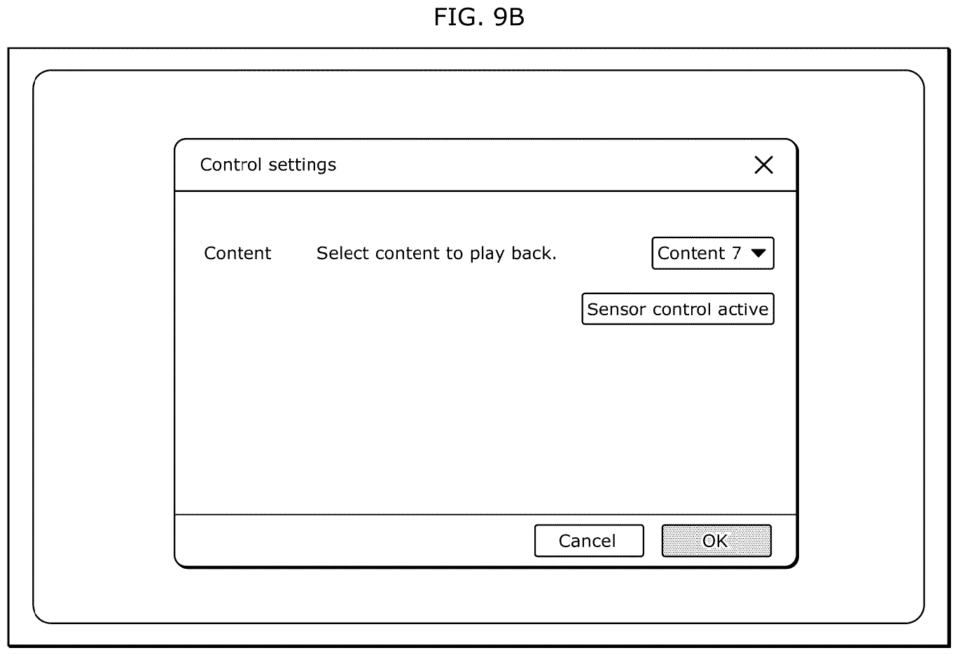

As described above, common software is installed in the plurality of wireless communication devices 20. However, when the operating mode is set, each of the plurality of wireless communication devices 20 operates in accordance with the operating mode set in that wireless communication device 20. For example, even if the plurality of wireless communication devices 20 receive the same control information (information in which the same control values are specified), those wireless communication devices 20 will behave differently when the operating modes thereof differ. FIG. 11 is a diagram illustrating an example of a relationship between the details of the control information and the operating mode.

In the example in FIG. 11, when wireless communication device 20 set to a “normal” lighting mode receives control information instructing light to be emitted at a dimming rate of 80%, wireless communication device 20 emits light at the dimming rate of 80% as instructed. However, when wireless communication device 20 set to a “power saving” lighting mode receives control information instructing light to be emitted at a dimming rate of 80%, wireless communication device 20 emits light at a dimming rate of 70%, which is lower than the instructed dimming rate.

Wireless communication device 20 may also greatly change the interpretation of the control information. For example, when wireless communication device 20 set to projector mode receives control information instructing light to be emitted at a dimming rate of 80%, wireless communication device 20 may interpret the dimming rate of 80% as identification information of content to be played back, and then play back the content corresponding to the dimming rate.

In this manner, the control performed by wireless communication device 20 when control information is received from information terminal 30 (wireless communicator 33) may differ depending on the operating mode set in wireless communication device 20.

### Setting Plurality of Operating Modes for One Wireless Communication Device

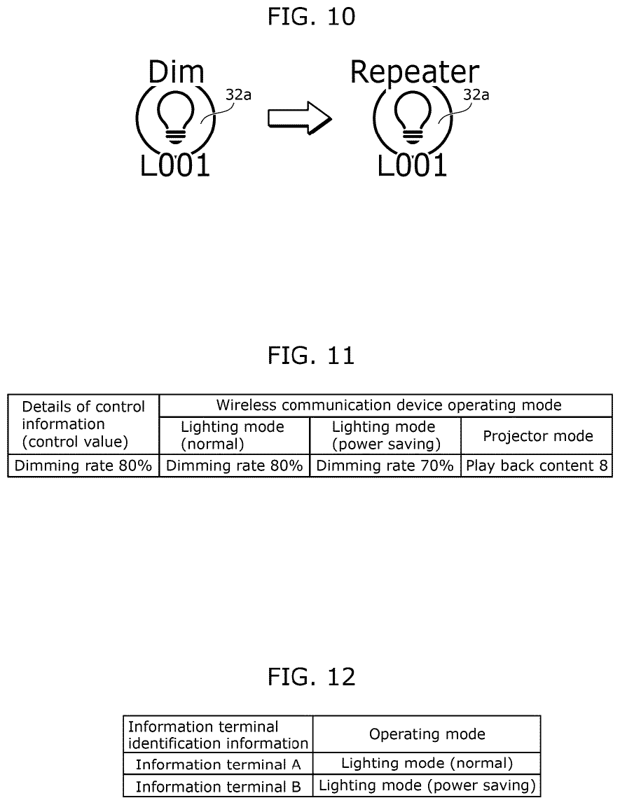

In the foregoing embodiment, one operating mode is set for one wireless communication device 20. However, a plurality of operating modes can also be set for one wireless communication device 20. For example, the plurality of operating modes set in the one wireless communication device 20 include an operating mode for information terminal A and an operating mode for information terminal B, which is a control terminal different from information terminal A. FIG. 12 is a diagram illustrating an example of settings for a plurality of operating modes.

As illustrated in FIG. 12, in one wireless communication device 20, a “normal” lighting mode is set as an operating mode for information terminal A and a “power saving” lighting mode is set as an operating mode for information terminal B, for example.

Then, when wireless communication device 20 for which the operating modes are set in this manner receives control information A, which instructs light to be emitted at a dimming rate of 80% and is sent from information terminal A, wireless communication device 20 operates in the “normal” lighting mode. In other words, wireless communication device 20 emits light at a dimming rate of 80%, as instructed.

However, when wireless communication device 20 receives control information B, which instructs light to be emitted at a dimming rate of 80% and is sent from information terminal B, wireless communication device 20 operates in the “power saving” lighting mode. In other words, wireless communication device 20 emits light at a dimming rate of 70%, which is lower than the dimming rate instructed.

In this manner, wireless communication device 20 for which a plurality of operating modes are set can operate in different operating modes according to the information terminal that sends the control information.

Note that the method for setting the operating mode is the same as described in Example 1 or Example 2 of the operating mode setting phase. At this time, the operating mode for information terminal A may be set using information terminal A, and the operating mode for information terminal B may be set using information terminal B; or, both the operating mode for information terminal A and the operating mode for information terminal B may be set using one information terminal 30 (information terminal A, information terminal B, or another information terminal 30).

### Variations

In the foregoing embodiment, wireless communication device 20 for which the operating mode has been set may emit a beacon signal including operating mode information indicating the operating mode currently set in wireless communication device 20. This enables information terminal 30 that receives the beacon signal to recognize the operating mode currently set in wireless communication device 20.

In the foregoing embodiment, each of the plurality of wireless communication devices 20 constituting the mesh network is described as a lighting-related device, such as a lighting fixture, a lighting remote controller, a PWM dimmer, a scheduler, a projector, an AC relay, a sensor, or the like. However, wireless communication device 20 may be a different device, such as an air conditioner, a ventilation device, a camera, a speaker, or the like.

### Effects, Etc.

Examples of inventions achieved from the content disclosed in the present specification will be given hereinafter, and effects and the like provided by the inventions will be described as well.

Invention 1 is information terminal 30 including: wireless communicator 33 that receives a beacon signal emitted by wireless communication device 20; display 32; information processor 34 that displays, on display 32, an operating mode selection screen displaying an option that varies depending on first information included in the beacon signal received; and operation acceptor 31 that accepts, from a user, a selection operation for selecting the operating mode. Using wireless communicator 33, information processor 34 sends, to wireless communication device 20, operating mode setting information for setting the operating mode selected by the selection operation in wireless communication device 20. The installing party in the foregoing embodiment is an example of the user.

The installing party in the foregoing embodiment is an example of the user.

This information terminal 30 can support the setting of an appropriate operating mode for wireless communication device 20 by displaying a selection screen including options considered appropriate, depending on the first information.

Invention 2 is information terminal 30 of Invention 1, wherein wireless communication device 20 is a lighting fixture, a sensor, or a scheduler that controls a schedule of the lighting fixture.

This information terminal 30 can support the setting of an appropriate operating mode for a lighting fixture, a sensor, or a scheduler.

Invention 3 is information terminal 30 of Invention 1 or 2, wherein the option includes a first operating mode for performing wireless communication and operating based on a device type of the wireless communication device, and a second operating mode for performing only wireless communication among wireless communication and operating based on a device type of the wireless communication device.

This information terminal 30 can support the setting of the first operating mode and the second operating mode.

Invention 4 is information terminal 30 of Invention 3, wherein the first operating mode includes an operating mode for a lighting fixture and an operating mode for a device other than a lighting fixture.

This information terminal 30 can support the setting of an operating mode for a lighting fixture and an operating mode for a device other than a lighting fixture.

Invention 5 is information terminal 30 of any one of Inventions 1 to 4, wherein information processor 34: accepts a group setting for setting a group of a plurality of wireless communication devices 20, each being wireless communication device 20, under a condition that the operating mode set in each of wireless communication devices 20 is a same operating mode; and based on the group setting accepted, sends control information for controlling the plurality of wireless communication devices 20 as a group to the group using wireless communicator 33.

This information terminal 30 can implement appropriate area control by having only wireless communication devices 20 for which the same operating mode is set belong to the same area.

Invention 6 is information terminal 30 of Invention 5, wherein information processor 34 excludes wireless communication device 20, among the plurality of wireless communication devices 20, for which a specific operating mode is set from the group setting.

This information terminal 30 can implement appropriate area control by excluding wireless communication device 20 for which the specific operating mode is set from the area control.

Invention 7 is information terminal 30 of any one of Inventions 1 to 6, wherein control performed by wireless communication device 20 when control information is received from wireless communicator 33 differs depending on the operating mode set in wireless communication device 20.

This information terminal 30 can cause wireless communication device 20 to perform different operations depending on the operating mode.

Invention 8 is information terminal 30 of any one of Inventions 1 to 7, wherein in accordance with the operating mode set in wireless communication device 20, information processor 34 changes a format in which icon 32a or a screen pertaining to wireless communication device 20 is displayed in display 32.

This information terminal 30 can change the display format of icon 32a or a screen pertaining to wireless communication device 20 according to the operating mode set in wireless communication device 20.

Invention 9 is information terminal 30 of any one of Inventions 1 to 8, wherein the beacon signal includes operating mode information indicating the operating mode currently set in wireless communication device 20.

This information terminal 30 can recognize the operating mode currently set in wireless communication device 20 by receiving the beacon signal.

Invention 10 is information terminal 30 of any one of Inventions 1 to 9, wherein the first information included in the beacon signal is device type information of wireless communication device 20, and information processor 34 determines the option according to the device type information, and displays the operating mode selection screen, including the option determined, on display 32.

This information terminal 30 can support the setting of an appropriate operating mode for wireless communication device 20 by displaying a selection screen including options considered appropriate, depending on the device type.

Invention 11 is information terminal 30 of any one of Inventions 1 to 9, wherein the first information included in the beacon signal is option information directly indicating the option, and information processor 34 displays the operating mode selection screen, including the option indicated by the option information, on display 32.

This information terminal 30 can support the setting of an appropriate operating mode for wireless communication device 20 by displaying a selection screen including options considered appropriate for wireless communication device 20.

Invention 12 is information terminal 30 of any one of Inventions 1 to 11, wherein a plurality of operating modes, each being the operating mode, are settable in wireless communication device 20.

This information terminal 30 can set a plurality of operating modes for wireless communication device 20.

Invention 13 is information terminal 30 of Invention 12, wherein the plurality of operating modes include an operating mode for information terminal 30 and an operating mode for a control terminal different from information terminal 30.

This information terminal 30 can cause wireless communication device 20 for which a plurality of operating modes are set to operate in different operating modes depending on the information terminal that sends the control information.

Invention 14 is communication system 10 including information terminal 30 according to any one of Inventions 1 to 13 and wireless communication device 20.

This communication system 10 can support the setting of an appropriate operating mode for wireless communication device 20 by displaying a selection screen including options considered appropriate, depending on the first information.

Invention 15 is a setting method executed by information terminal 30 including display 32. The setting method includes: step S10b of receiving a beacon signal emitted by wireless communication device 20; step S40b of displaying, on display 32, an operating mode selection screen displaying an option that varies depending on first information included in the beacon signal received; step S140c of accepting, from a user, a selection operation for selecting the operating mode; and step S40d of sending, to wireless communication device 20, operating mode setting information for setting the operating mode selected by the selection operation in wireless communication device 20.

This setting method can support the setting of an appropriate operating mode for wireless communication device 20 by displaying a selection screen including options considered appropriate, depending on the first information.

Invention 16 is a non-transitory computer-readable recording medium having recorded thereon a program for causing information terminal 30 to execute the setting method of Invention 15.

According to this program, information terminal 30 can support the setting of an appropriate operating mode for wireless communication device 20 by displaying a selection screen including options considered appropriate, depending on the first information.

### Other Embodiments

Although an embodiment has been described thus far, the present disclosure is not limited to the foregoing embodiment.

For example, processing executed by a specific processing unit in the foregoing embodiment may be executed by a different processing unit. Additionally, the order of multiple processes may be changed, and multiple processes may be executed in parallel.

Additionally, in the foregoing embodiment, the constituent elements may be implemented by executing software programs corresponding to those constituent elements. Each constituent element may be realized by a program executing unit such as a CPU or a processor reading out and executing a software program recorded into a recording medium such as a hard disk or semiconductor memory.

Each constituent element may be implemented by hardware. For example, constituent elements such as controllers may be circuitry (or integrated circuitry). This circuitry may constitute a single overall circuit, or may be separate circuits. The circuitry may be generic circuitry, or may be dedicated circuitry.

The general or specific aspects of the present disclosure may be implemented by a system, a device, a method, an integrated circuit, a computer program, or a computer-readable recording medium such as a CD-ROM. These forms may also be implemented by any desired combination of systems, devices, methods, integrated circuits, computer programs, and recording media.

For example, the present disclosure may be implemented as a communication system or an information terminal according to the foregoing embodiment, or as a setting method executed by an information terminal. The present disclosure may be implemented as a program for causing an information terminal (a computer) to execute such a setting method, or as a non-transitory computer-readable recording medium having such a program recorded thereon. The program is, in other words, a computer program product. Such a program includes an application program for causing a computer, such as a general-purpose information terminal or the like, to function as an information terminal according to the foregoing embodiments.

Note that embodiments resulting from variations of the above embodiments arrived at by those skilled in the art, as well as embodiments resulting from optional combinations of elements and functions in the above embodiments, are included within the present disclosure as long as the embodiments do not depart from the scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. An information terminal comprising:
a wireless communicator that receives a beacon signal emitted by a wireless communication device;
a display;
an information processor that displays, on the display, an operating mode selection screen displaying an option that varies depending on first information included in the beacon signal received; and
an operation acceptor that accepts, from a user, a selection operation for selecting the operating mode,
wherein using the wireless communicator, the information processor sends, to the wireless communication device, operating mode setting information for setting the operating mode selected by the selection operation in the wireless communication device.

2. The information terminal according to claim 1,
wherein the wireless communication device is a lighting fixture, a sensor, or a scheduler that controls a schedule of the lighting fixture.

3. The information terminal according to claim 1,
wherein the option includes a first operating mode for performing wireless communication and operating based on a device type of the wireless communication device, and a second operating mode for performing only wireless communication among wireless communication and operating based on a device type of the wireless communication device.

4. The information terminal according to claim 3,
wherein the first operating mode includes an operating mode for a lighting fixture and an operating mode for a device other than a lighting fixture.

5. The information terminal according to claim 1,
wherein the information processor:
accepts a group setting for setting a group of a plurality of wireless communication devices, each being the wireless communication device, under a condition that the operating mode set in each of the wireless communication devices is a same operating mode; and
based on the group setting accepted, sends control information for controlling the plurality of wireless communication devices as a group to the group using the wireless communicator.

6. The information terminal according to claim 5,
wherein the information processor excludes a wireless communication device, among the plurality of wireless communication devices, for which a specific operating mode is set from the group setting.

7. The information terminal according to claim 1,
wherein control performed by the wireless communication device when control information is received from the wireless communicator differs depending on the operating mode set in the wireless communication device.

8. The information terminal according to claim 1,
wherein in accordance with the operating mode set in the wireless communication device, the information processor changes a format in which an icon or a screen pertaining to the wireless communication device is displayed in the display.

9. The information terminal according to claim 1,
wherein the beacon signal includes operating mode information indicating the operating mode currently set in the wireless communication device.

10.
The information terminal according to claim 1,
wherein the first information included in the beacon signal is device type information of the wireless communication device, and
the information processor determines the option according to the device type information, and displays the operating mode selection screen, including the option determined, on the display.

11. The information terminal according to claim 1,
wherein the first information included in the beacon signal is option information directly indicating the option, and
the information processor displays the operating mode selection screen, including the option indicated by the option information, on the display.

12. The information terminal according to claim 1,
wherein a plurality of operating modes, each being the operating mode, are settable in the wireless communication device.

13. The information terminal according to claim 12,
wherein the plurality of operating modes include an operating mode for the information terminal and an operating mode for a control terminal different from the information terminal.

14. A communication system comprising:
the information terminal according to claim 1; and
the wireless communication device.

15. A setting method executed by an information terminal including a display, the setting method comprising:
receiving a beacon signal emitted by a wireless communication device;
displaying, on the display, an operating mode selection screen displaying an option that varies depending on first information included in the beacon signal received;
accepting, from a user, a selection operation for selecting the operating mode; and
sending, to the wireless communication device, operating mode setting information for setting the operating mode selected by the selection operation in the wireless communication device.

16. A non-transitory computer-readable recording medium having recorded thereon a program for causing the information terminal to execute the setting method according to claim 15.
